(19) United States
(12) Patent Application Publication
(10) Pub. No.: US 2019/0040572 A1
(43) Pub. Date: Feb. 7, 2019

(54) ARTIFICIAL LEATHER AND METHOD OF MANUFACTURING THE SAME

(71) Applicants: HYUNDAI MOTOR COMPANY, Seoul (KR); KIA MOTORS CORPORATION, Seoul (KR)

(72) Inventors: Hyemin LEE, Seoul (KR); Won Jin SEO, Suwon-si (KR); Gun KANG, Seoul (KR); SoonJoon JUNG, Seoul (KR); Mi Jung YUN, Yongin-si (KR); Hyuk-Jae YOU, Yongin-si (KR); Jong-Ho PARK, Yongin-si (KR); Eung-Min LEE, Yongin-si (KR)

(21) Appl. No.: 15/829,104

(22) Filed: Dec. 1, 2017

(30) Foreign Application Priority Data
Aug. 7, 2017 (KR) 10-2017-0099632

(51) Int. Cl. D06N 3/00; D06M 15/564; D06M 23/16

(52) U.S. Cl. CPC D06N 3/0004; D06M 15/564; B60N 2/58; D06N 3/0063; D06M 23/16

(57) ABSTRACT

Embodiments of the present disclosure relate to artificial leather and a method of manufacturing the same, and more particularly, to suede artificial leather for a vehicle seat with improved light fastness and tactile sensitivity, and a method of manufacturing the same. In accordance with one aspect of the present disclosure, a method of manufacturing artificial leather comprise needle-punching a sea-island type ultrafine conjugated yarn having a sea component of easily soluble polyester and an island component of a polyester black dope-dyed yarn to form a nonwoven fabric; wet-impregnating a polyurethane resin in the nonwoven fabric; eluting the sea component of the nonwoven fabric; dyeing and reduction-cleaning the nonwoven fabric from which the sea component is eluted; and performing in-bath flame-retardant treatment on the cleaned nonwoven fabric.

### CROSS-REFERENCE TO RELATED APPLICATION

This application is based on and claims the benefit of priority to Korean Patent Application No. 10-2017-0099632, filed on Aug. 7, 2017 with the Korean Intellectual Property Office, the disclosure of which is incorporated herein by reference.

### TECHNICAL FIELD

Embodiments of the present disclosure relate to artificial leather and a method of manufacturing the same, and more particularly, to suede artificial leather for a vehicle seat with improved light fastness and tactile sensitivity, and a method of manufacturing the same.

### BACKGROUND

Artificial leather is widely used as a material for interior surfaces of vehicle, such as vehicle seats, etc., thanks to its unique appearance and a soft texture similar to natural leather. Recently, many vehicles use artificial leather, instead of woven fabrics, knitted fabrics, and natural leather. Particularly, interior materials for seats or instrument panels generally use deep black colors. Since seats or instrument panels are often exposed to sunlight, they should satisfy a high light-resistance evaluation level, in addition to having a soft texture.

Since artificial leather is manufactured using ultrafine fibers, it has low light fastness. Further, if a flame retardant is coated on the surface of artificial leather for flame-retardant treatment, the artificial leather is stiffened so that the emotional quality of the artificial leather is degraded, and also wrinkles may be made while being stiffened. In addition, a method of putting a flame retardant in a bath to absorb it for dyeing artificial leather lowers the dye uptake rates and may produce dye stains. Accordingly, in order to extend application of artificial leather to an interior material for vehicle, technologies for obtaining high light fastness without causing problems such as dyeing defects, etc., during a manufacturing process, and for maintaining the unique soft texture of artificial leather even after flame-retardant treatment need to be developed.

### SUMMARY

Therefore, it is an aspect of the present disclosure to provide artificial leather manufactured by producing a nonwoven fabric with a sea-island type ultrafine conjugated yarn, and then performing flame-retardant treatment on the nonwoven fabric using an in-bath flame retarding method, and a method of manufacturing the artificial leather, wherein a sea component of the sea-island type ultrafine conjugated yarn is formed with easily soluble polyester, and an island component of the sea-island type ultrafine conjugated yarn is formed with a polyester black dope-dyed yarn.

Additional aspects of the disclosure will be set forth in part in the description which follows and, in part, will be obvious from the description, or may be learned by practice of the disclosure.

In accordance with one aspect of the present disclosure, a method of manufacturing artificial leather comprise steps of needle-punching a sea-island type ultrafine conjugated yarn having a sea component of easily soluble polyester and an island component of a polyester black dope-dyed yarn to form a nonwoven fabric; wet-impregnating a polyurethane resin in the nonwoven fabric; eluting the sea component of the nonwoven fabric; dyeing and reduction-cleaning the nonwoven fabric from which the sea component is eluted; and performing in-bath flame-retardant treatment on the cleaned nonwoven fabric.

In the step of needle-punching a sea-island type ultrafine conjugated yarn to form the nonwoven fabric, the polyester black dope-dyed yarn being the island component of the sea-island ultrafine conjugated yarn may contain a carbon black component.

In the step of needle-punching a sea-island type ultrafine conjugated yarn to form the nonwoven fabric, the island component may contain the carbon black ranging from 1.5 weight % to 3 weight % with respect to total weight of the island component.

In the step of needle-punching a sea-island type ultrafine conjugated yarn to form a nonwoven fabric, denier per filament of the island component may range from 0.04 denier to 0.3 denier.

In the step of needle-punching a sea-island type ultrafine conjugated yarn to form a nonwoven fabric, the sea-island ultrafine conjugated yarn may have 7 to 36 fibers included in the island component for each unit filament.

The step of wet-impregnating a polyurethane resin in the nonwoven fabric may comprise wet-impregnating the polyurethane resin in the nonwoven fabric such that the polyurethane resin of 27.5 weight % to 31 weight % with respect to total weight of the artificial leather is included in the nonwoven fabric.

The step of performing in-bath flame-retardant treatment on the cleaned nonwoven fabric may comprise performing in-bath flame-retardant treatment on the cleaned nonwoven fabric using a phosphate ester flame retardant of 15 weight % to 30 weight % with respect to weight of the artificial leather.

The step of performing in-bath flame-retardant treatment on the cleaned nonwoven fabric may comprise performing in-bath flame-retardant treatment on the cleaned nonwoven fabric in a bath containing the phosphate ester flame retardant at a liquid ratio of 1:5 to 1:30.

The method may further comprise buffing the nonwoven fabric to raise a nap on a surface of the nonwoven fabric.

According to another aspect of the present disclosure, artificial leather may comprise a nonwoven fabric formed by needle-punching a sea-island type ultrafine conjugated yarn having a sea component of easily soluble polyester and an island component of a polyester black dope-dyed yarn, and eluting the sea component; and an elastic layer formed by wet-impregnating the polyurethane resin in the nonwoven fabric.

The nonwoven fabric and the elastic layer may be formed by dyeing and reduction-cleaning the elastic layer and the nonwoven fabric from which the sea component is eluted, and performing in-bath flame-retardant treatment on the cleaned nonwoven fabric and the cleaned elastic layer.

The polyester black dope-dyed yarn of the nonwoven fabric may contain a carbon black component.

The nonwoven fabric may contain the carbon black of 1.5 weight % to 3 weight % with respect to total weight of the sea component.

The denier per filament of the sea component may range from 0.04 denier to 0.3 denier.

The nonwoven fabric may have 7 to 36 fibers included in the island component for each unit filament.

The elastic layer may contain the polyurethane resin of 27.5 weight % to 31 weight % with respect to total weight of the artificial leather.

A nap may be raised on at least one surface of the nonwoven fabric.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a flowchart illustrating a method of manufacturing artificial leather according to an embodiment of the present disclosure.

FIG. 2 shows a structure of artificial leather manufactured by the method of FIG. 1.

FIG. 3 shows a view showing a method of evaluation the stiffness of an artificial leather.

### DETAILED DESCRIPTION

Like reference numerals refer to like elements throughout this specification. This specification does not describe all components of embodiments, and general information in the technical field to which the present disclosure belongs or overlapping information between the embodiments will not be described.

Also, it will be understood that when the terms “includes,” “comprises,” “including,” and/or “comprising,” when used in this specification, specify the presence of a stated component, but do not preclude the presence or addition of one or more other components.

In this specification, it will be understood that, although the terms first, second, etc. may be used herein to describe various components, these components should not be limited by these terms. These terms are only used to distinguish one component from another.

Also, it is to be understood that the singular forms “a,” “an,” and “the” include plural referents unless the context clearly dictates otherwise.

Reference numerals used in operations are provided for convenience of description, without describing the order of the operations, and the operations can be executed in a different order from the stated order unless a specific order is definitely specified in the context.

Hereinafter, the operation principle and embodiments of the present disclosure will be described with reference to the accompanying drawings.

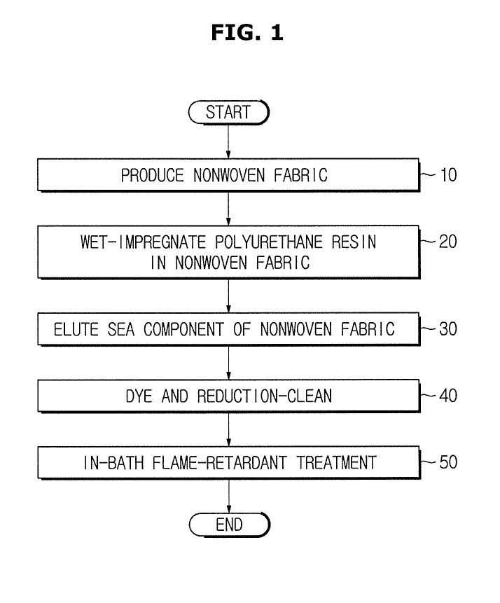

FIG. 1 is a flowchart illustrating a method of manufacturing artificial leather according to an embodiment of the present disclosure. Referring to FIG. 1, a method of manufacturing artificial leather according to an embodiment of the present disclosure may include: operation 10 of needle-punching a sea-island type ultrafine conjugated yarn to form a nonwoven fabric; operation 20 of wet-impregnating a polyurethane resin in the nonwoven fabric; operation 30 of eluting a sea component of the nonwoven fabric; operation 40 of dyeing and reduction-cleaning the nonwoven fabric from which the sea component is eluted; and operation 50 of performing flame-retardant treatment on the cleaned nonwoven fabric.

First, operation 10 of needle-punching a sea-island type ultrafine conjugated yarn to form a nonwoven fabric may be to needle-punch a sea-island type ultrafine conjugated yarn having a sea component of easily soluble polyester and an island component of a polyester black dope-dyed yarn to form a nonwoven fabric. More specifically, a nonwoven fabric may be formed by producing multiple layers of webs with a sea-island type ultrafine conjugated yarn through carding and cross-lapping, and then needle-punching the multiple layers of webs.

The polyester black dope-dyed yarn may include a carbon black component, more specifically, a carbon black master batch. Carbon black may have excellent light fastness compared to dyes. The present disclosure provides artificial leather having excellent light fastness by using a carbon black master batch together with dyes to implement black color of the artificial leather.

The polyester black dope-dyed yarn may contain a carbon black component ranging from 1.5 weight % to 3 weight % with respect to total weight of the island component.

The present disclosure is aimed to provide black artificial leather having excellent light fastness, as described above. If the concentration of carbon black is lower than or equal to 1.5 weight %, the blackness of the artificial leather not dyed may be low so that a large amount of dyes are required to implement a desired high-concentration of black color. Since the dyes have lower light fastness than carbon black, most of the dyes may be disrupted when the light fastness of the artificial leather is evaluated. As a result, black color may be implemented with a small amount of carbon black so that the light fastness of the artificial leather may be degraded. On the contrary, if the concentration of carbon black is higher than or equal to 3 weight %, an apparent concentration may reach a saturation value so that an increase of the apparent concentration cannot be checked with naked eyes although the concentration of carbon black increases. Accordingly, it is preferable to appropriately adjust a carbon black content in consideration of a desired blackness and a desired level of light fastness.

The polyester black dope-dyed yarn may have denier per filament ranging from 0.04 denier to 0.3 denier. If a lower limit of the denier of the island component is smaller than or equal to 0.04 denier, problems, such as degradation of dyeing properties and degradation of light fastness, may be generated. In other words, if the thickness of a fiber included in the island component is too thin, a large amount of dyes may be used to represent desired color, and if a large amount of dyes is used, light fastness may be degraded. Meanwhile, if an upper limit of the denier of the island component is greater than or equal to 0.3 denier, the fiber may be thickened and stiffened so that the tactile sensation of the artificial leather is degraded. Accordingly, it is preferable to adjust denier per filament of the polyester black dope-dyed yarn in consideration of desired light fastness properties and desired tactile sensation of the artificial leather.

Then, a process of wet-impregnating a polyurethane resin in the nonwoven fabric to produce a nonwoven fabric in which elastomers are impregnated may be performed. More specifically, by soaking the nonwoven fabric in an impregnating solution containing polyurethane, a nonwoven fabric in which polyurethane elastomers are impregnated may be produced. According to an embodiment, the impregnating solution may contain carbon black, in addition to polyurethane.

Operation of wet-impregnating the polyurethane resin in the nonwoven fabric may include operation of impregnating the polyurethane resin in the nonwoven fabric such that the polyurethane resin of 27.5 weight % to 31 weight % with respect to total weight of the artificial leather is included in the artificial leather. If a portion of polyurethane as polymeric elastomers with respect to the total weight of the artificial leather is smaller than or equal to 27.5 weight %, the elastic property of the artificial leather may be degraded so as to offer tactile sensation of fibers rather than leather. Meanwhile, if the portion of polyurethane is larger than or equal to 31 weight %, the artificial leather may be stiffened so as to offer tactile sensation of paper. Accordingly, it is preferable to appropriately adjust a polyurethane resin content with respect to the total weight of the artificial leather.

Then, operation of eluting the sea component of the nonwoven fabric may be performed. Operation of eluting the sea component of the nonwoven fabric may include operation of processing the nonwoven fabric in which the polyurethane resin is impregnated with an alkali solution to elute the sea component from the nonwoven fabric. Since the sea component of the artificial leather is easily soluble polyester, the sea component can easily dissolve in an alkali aqueous solution.

Then, operation of buffing the nonwoven fabric from which the sea component is eluted to raise a nap on the surface may be performed. Operation of buffing the nonwoven fabric may be operation of grinding the surface of the nonwoven fabric with a sandpaper to buff the nonwoven fabric.

Then, operation of dyeing and reduction-cleaning the nonwoven fabric from which the sea component is eluted may be performed. At this time, the nonwoven fabric may be dyed with an anthraquinone dye. However, the nonwoven fabric may be dyed with another kind of dye. After dyeing is completed, the remaining dyeing solution may be discharged from a dyeing machine, water may be again filled in the dyeing machine, and then reduction-cleaning may performed. The cleaning may be performed several times as necessary.

Then, operation of performing flame-retardant treatment on the cleaned nonwoven fabric in a bath may be performed. The flame-retardant treatment may be operation of absorbing a phosphate ester flame retardant of 15 weight % to 30 weight % with respect to the total weight of the artificial leather at a liquid ratio of 1:5 to 1:30 after dyeing and reduction-cleaning. Meanwhile, according to an embodiment, during the flame-retardant treatment, an additive such as a nonionic fatty acid ester dispersant may be additionally added together with the flame retardant.

In the present disclosure, by performing in-bath flame-retardant treatment after dyeing and reduction-cleaning, a problem in which an in-bath flame retardant used in dyeing is taken off during reduction-cleaning can be prevented. Thereby, artificial leather for a vehicle interior material having excellent flame retardancy and a unique soft texture can be provided.

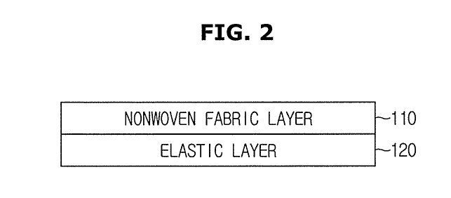

A method of manufacturing the artificial leather according to an embodiment of the present disclosure has been described above. The artificial leather manufactured by the above-described method may have a structure shown in FIG. 2.

FIG. 2 shows a structure of artificial leather 1 manufactured by the method of FIG. 1. As shown in FIG. 2, artificial leather 1 according to an embodiment may include a nonwoven fabric layer 110 formed by needle-punching an easily soluble sea-island type ultrafine conjugated yarn and eluting a sea component, and an elastic layer 120 formed by wet-impregnating a polyurethane resin in the nonwoven fabric layer 110.

The nonwoven fabric layer 110 may be formed by needle-punching a sea-island type ultrafine conjugated yarn having a sea component of polyester and an island component of a polyester black dope-dyed yarn, and eluting the sea component. Meanwhile, according to an embodiment, a nap may be raised on the surface of the nonwoven fabric by buffing the surface of the nonwoven fabric.

The island component of the nonwoven fabric layer 110 may be formed with a polyester black dope-dyed yarn, and the polyester black dope-dyed yarn may have denier per filament ranging from 0.04 denier to 0.3 denier. The denier per filament of the polyester black dope-dyed yarn has been described above, and accordingly, a detailed description thereof will be omitted.

The nonwoven fabric may implement black color by a carbon black master batch attached on the polyester dope-dyed yarn. In order to implement black color of the artificial leather 1 according to the present disclosure, the island component of the nonwoven fabric may contain a carbon black master batch of 1.5 weight % to 3 weight % with respect to the total weight of the island component. Limits to the amount of the carbon black master batch have been described above, and accordingly, a detailed description thereof will be omitted.

In the nonwoven fabric, the number of fibers included in the island component for each unit filament may be 7 to 36. The number of fibers included in the island component for each unit filament of the nonwoven fabric relates to the denier per filament of the polyester black dope-dyed yarn as described above. That is, if the denier per filament of the polyester black dope-dyed yarn is low, the number of fibers included in the island component for each unit filament may be great, and if the denier per filament of the polyester black dope-dyed yarn is high, the number of fibers included in the island component for each unit filament may be small.

The nonwoven fabric may be formed by dyeing and reduction-cleaning the nonwoven fabric from which the sea component is eluted, and then performing flame-retardant treatment on the cleaned nonwoven fabric in a bath. In other words, by performing flame-retardant treatment on the nonwoven fabric in a bath after dyeing and reduction-cleaning, a flame retardant can be sufficiently absorbed in the nonwoven fabric, thereby providing artificial leather for a vehicle interior material having excellent flame retardancy.

The elastic layer 120 may be formed to provide the artificial leather 1 with an elastic property. The elastic layer 120 may be formed by wet-impregnating a polyester urethane resin in the nonwoven fabric. More specifically, by soaking the nonwoven fabric in an impregnating solution containing polyurethane, a nonwoven fabric in which polyurethane elastomers are impregnated may be produced.

In FIG. 2, an example in which an elastic layer 120 is formed on the entire of one surface of the nonwoven fabric is shown. However, according to other embodiments, elastic layers may be formed on both surfaces of the nonwoven fabric, or an elastic layer may be formed on an area of the nonwoven fabric.

The artificial leather according to the present disclosure and the method of manufacturing the artificial leather have been described above. Hereinafter embodiments of methods of manufacturing the artificial leather according to the present disclosure will be described for easy understanding. The following embodiments are provided for better understanding, and the technical concept of the present disclosure is not limited to the embodiments.

### Embodiment 1

1) Manufacturing of a Sea-Island Type Ultrafine Conjugated Yarn

Polyethylene terephthalate as an island component and alkali soluble polyester copolymer as a sea component are prepared, and the island component and the sea component are put into an extruder to melt and extrude the island component and the sea component. When the island component is melted and extruded, a carbon black master batch is added to the island component by side-feeding, and the result is discharged through a spinning nozzle. Thereby, a sea-island type filament is manufactured in which a carbon black content in the island component of the black polyethylene terephthalate is 1.5 weight %, and the number of fibers for each filament is 16. Successively, the filament is stretched so that denier per filament of the island component becomes 0.15 denier, crimping is performed such that the number of crimps becomes 10 pieces/inch, heat setting is performed, and then cutting to 51 mm is performed, thereby producing a sea-island type ultrafine conjugated yarn.

2) Manufacturing of a Nonwoven Fabric

Carding and cross-lapping are performed on the sea-island type ultrafine conjugated yarn to produce multiple layers of webs. Successively, needle-punching is performed on the multiple layers of webs, and the multiple layers of webs are processed for 5 minutes at temperature of 100° C. and relative humidity of 90% using steam to produce a nonwoven fabric having apparent density of 0.3 g/cm³.

3) Manufacturing of a Nonwoven Fabric in which Elastomers are Impregnated.

The nonwoven fabric is soaked in an impregnating solution containing polyurethane and carbon black, polyurethane is coagulated in a dimethyl formamide solution, and then cleaning is performed with water so that a nonwoven fabric is produced in which polyurethane elastomers containing carbon black of 5 weight % are impregnated by 30 weight %.

4) Manufacturing of Artificial Leather

The nonwoven fabric in which the black polyurethane is impregnated is processed with a sodium hydroxide solution of 5 weight % to elute the sea component, thereby producing an elution fabric forming a nonwoven fabric of black polyethylene terephthalate fibers having 16 fibers for each filament and denier per filament of 0.15 denier. Then, the surface of the elution fabric is grinded with a sandpaper of roughness No. #150 to raise a nap, and then the elution fabric is dyed under the following dyeing conditions. A dye mixture of an anthraquinone black disperse dye of 0.8 weight %, an anthraquinone red disperse dye of 0.5 weight %, an anthraquinone blue disperse dye of 1.5 weight %, and an anthraquinone yellow disperse dye of 0.5 weight %, with respect to the total weight of fibers, is used to dye the elution fabric. Also, a triazine derivative of 4.0 weight % with respect to the total weight of fibers is used as a UV absorber, and nonionic fatty acid ester of 1 g/L is used as a dispersant, acetic acid of 1 g/L is used as acid, and a liquid ratio is adjusted to 1:20. After dyeing is completed under the above conditions, the remaining dyeing solution is discharged from a dyeing machine, water is again filled in the dyeing machine, and then reduction-cleaning is performed at temperature of 80° C. for 20 minutes under reduction-cleaning conditions (sodium hydrosulfite of 8 g/L, sodium hydroxide of 4 g/L, and a liquid ratio of 1:20)

After reduction-cleaning is completed, operation of supplying water to the dyeing machine and then washing off the remaining dye hydrolysates and alkali is performed four times, and then in-bath flame-retardant treatment is performed. The in-bath flame-retardant treatment is performed using a phosphate ester flame retardant of 25.0 weight % with respect to the total weight of fibers and nonionic fatty acid ester of 1 g/L as a dispersant, and a liquid ratio is adjusted to 1:20. Also, the in-bath flame-retardant treatment is performed at processing temperature of 80° C. for 30 minutes. After the in-bath flame-retardant treatment is completed, the remaining solution is discharged, and water is supplied to the dyeing machine to remove unabsorbed flame retardants and dispersants, and then washing and drying are performed to thereby manufacture artificial leather.

### Embodiment 2

The embodiment 2 is the same as the embodiment 1, except that the number of fibers for each sea-island type filament is 36, and the denier per filament of the island component is 0.04 denier when the sea-island type ultrafine conjugated yarn is manufactured according to the embodiment 1.

### Embodiment 3

The embodiment 3 is the same as the embodiment 1, except that the number of fibers for each sea-island type filament is 7, and the denier per filament of the island component is 0.25 denier when the sea-island type ultrafine conjugated yarn is manufactured according to the embodiment 1.

### COMPARATIVE EXAMPLE 1

When the sea-island type ultrafine conjugated yarn is manufactured according to the embodiment 1, carbon black of 1.0 weight % is used in the island component of black polyethylene terephthalate

Also, the comparative example 1 is the same as the embodiment 1, except that a dye mixture of an anthraquinone black disperse dye of 2.04 weight %, an anthraquinone red disperse dye of 1.292 weight %, an anthraquinone blue disperse dye of 3.842 weight %, and an anthraquinone yellow disperse dye of 1.02 weight %, with respect to the total weight of fibers, is used in order to implement the same color as in the embodiment 1.

### COMPARATIVE EXAMPLE 2

When the sea-island type ultrafine conjugated yarn is manufactured according to the embodiment 1, carbon black of 0 weight % is used in the island component of black polyethylene terephthalate.

Also, the comparative example 2 is the same as the embodiment 1, except that a dye mixture of an anthraquinone black disperse dye of 11.02 weight %, an anthraquinone red disperse dye of 2.41 weight %, an anthraquinone blue disperse dye of 5.23 weight %, and an anthraquinone yellow disperse dye of 10.8 weight %, with respect to the total weight of fibers, is used in order to implement the same color as in the embodiment 1.

### COMPARATIVE EXAMPLE 3

When the sea-island type ultrafine conjugated yarn is manufactured according to the embodiment 1, a sea-island type filament containing carbon black of 1.0 weight % and 36 fibers for each filament in the island component of black polyethylene terephthalate is manufactured, and then, the filament is grinded to adjust denier per filament of the island component to 0.04 denier.

Also, the comparative example 3 is the same as the embodiment 1, except that a dye mixture of an anthraquinone black disperse dye of 2.04 weight %, an anthraquinone red disperse dye of 1.292 weight %, an anthraquinone blue disperse dye of 3.842 weight %, and an anthraquinone yellow disperse dye of 1.02 weight %, with respect to the total weight of fibers, is used in order to implement the same color as in the embodiment 1.

### COMPARATIVE EXAMPLE 4

When the sea-island type ultrafine conjugated yarn is manufactured according to the embodiment 1, a sea-island type filament containing carbon black of 0 weight % and 36 fibers for each filament in the island component of black polyethylene terephthalate is manufactured, and then the filament is grinded to adjust denier per filament of the island component to 0.04 denier.

Also, the comparative example 4 is the same as the embodiment 1, except that a dye mixture of an anthraquinone black disperse dye of 11.02 weight %, an anthraquinone red disperse dye of 2.41 weight %, an anthraquinone blue disperse dye of 5.23 weight %, and an anthraquinone yellow disperse dye of 10.8 weight %, with respect to the total weight of fibers, is used in order to implement the same color as in the embodiment 1.

### COMPARATIVE EXAMPLE 5

When the sea-island type ultrafine conjugated yarn is manufactured according to the embodiment 1, a sea-island type filament containing carbon black of 1.0 weight % and 7 fibers for each filament in the island component of black polyethylene terephthalate is manufactured, and then the filament is grinded to adjust denier per filament of the island component to 0.25 denier.

Also, the comparative example 5 is the same as the embodiment 1, except that a dye mixture of an anthraquinone black disperse dye of 2.04 weight %, an anthraquinone red disperse dye of 1.292 weight %, an anthraquinone blue disperse dye of 3.842 weight %, and an anthraquinone yellow disperse dye of 1.02 weight %, with respect to the total weight of fibers, is used in order to implement the same color as in the embodiment 1.

### COMPARATIVE EXAMPLE 6

When the sea-island type ultrafine conjugated yarn is manufactured according to the embodiment 1, a sea-island type filament containing carbon black of 0 weight % and 7 fibers for each filament in the island component of black polyethylene terephthalate is manufactured, and then the filament is grinded to adjust denier per filament of the island component to 0.25 denier.

Also, the comparative example 6 is the same as the embodiment 1, except that a dye mixture of an anthraquinone black disperse dye of 11.02 weight %, an anthraquinone red disperse dye of 2.41 weight %, an anthraquinone blue disperse dye of 5.23 weight %, and an anthraquinone yellow disperse dye of 10.8 weight %, with respect to the total weight of fibers, is used in order to implement the same color as in the embodiment 1.

### COMPARATIVE EXAMPLE 7

The comparative example 7 is the same as the embodiment 1, except that flame-retardant treatment is performed during one-bath dyeing as flame-retardant treatment when the artificial leather is manufactured according to the embodiment 1.

### COMPARATIVE EXAMPLE 8

The comparative example 8 is the same as the embodiment 1, except that knife-coating with a phosphorus-based power type flame retardant is performed as flame-retardant treatment when the artificial leather is manufactured according to the embodiment 1.

Conditions for manufacturing artificial leather, according to the embodiments 1 to 3 and the comparative examples 1 to 8, are expressed in Table 1 below.

TABLE 1

| | Carbon | | | | | | | |
|---|---|---|---|---|---|---|---|---|
| | Black | | Denier Per | | | | | |
| | Content in | Number of | Filament of | | Composite of Disperse Dyes | | | |
| | Island | Island | Island | Flame- | *Implement Same color as in | | | |
| | Component | Components | Component | Retardant | Embodiment 1 | | | |
| Classification | (weight %) | (Pieces) | (Denier) | Method | Black | Red | Blue | Yellow |
| Embodiment 1 | 1.5 | 16 | 0.15 | In-Bath | 0.8 | 0.5 | 1.5 | 0.5 |
| | | | | Flame- | | | | |
| | | | | Retardant | | | | |
| | | | | Treatment | | | | |
| | | | | After Dyeing | | | | |
| Comparative | 1.0 | 16 | 0.15 | In-Bath | 2.04 | 1.292 | 3.842 | 1.02 |
| Example 1 | | | | Flame- | | | | |
| | | | | Retardant | | | | |
| | | | | Treatment | | | | |
| | | | | After Dyeing | | | | |
| Comparative | 0.0 | 16 | 0.15 | In-Bath | 11.02 | 2.41 | 5.23 | 10.8 |
| Example 2 | | | | Flame- | | | | |
| | | | | Retardant | | | | |
| | | | | Treatment | | | | |
| | | | | After Dyeing | | | | |
| Embodiment 2 | 1.5 | 36 | 0.04 | In-Bath | 0.8 | 0.5 | 1.5 | 0.5 |
| | | | | Flame- | | | | |
| | | | | Retardant | | | | |
| | | | | Treatment | | | | |
| | | | | After Dyeing | | | | |
| Comparative | 1.0 | 36 | 0.04 | In-Bath | 2.04 | 1.292 | 3.842 | 1.02 |
| Example 3 | | | | Flame- | | | | |
| | | | | Retardant | | | | |
| | | | | Treatment | | | | |
| | | | | After Dyeing | | | | |
| Comparative | 0.0 | 36 | 0.04 | In-Bath | 11.02 | 2.41 | 5.23 | 10.8 |
| Example 4 | | | | Flame- | | | | |
| | | | | Retardant | | | | |
| | | | | Treatment | | | | |
| | | | | After Dyeing | | | | |
| Embodiment 3 | 1.5 | 7 | 0.25 | In-Bath | 0.8 | 0.5 | 1.5 | 0.5 |
| | | | | Flame- | | | | |
| | | | | Retardant | | | | |
| | | | | Treatment | | | | |
| | | | | After Dyeing | | | | |
| Comparative | 1.0 | 7 | 0.25 | In-Bath | 2.04 | 1.292 | 3.842 | 1.02 |
| Example 5 | | | | Flame- | | | | |
| | | | | Retardant | | | | |
| | | | | Treatment | | | | |
| | | | | After Dyeing | | | | |
| Comparative | 0.0 | 7 | 0.25 | In-Bath | 11.02 | 2.41 | 5.23 | 10.8 |
| Example 6 | | | | Flame- | | | | |
| | | | | Retardant | | | | |
| | | | | Treatment | | | | |
| | | | | After Dyeing | | | | |
| Comparative | 1.5 | 16 | 0.15 | Flame- | 0.8 | 0.5 | 1.5 | 0.5 |
| Example 7 | | | | Retardant | | | | |
| | | | | Treatment | | | | |
| | | | | During One- | | | | |
| | | | | bath Dyeing | | | | |
| Comparative | 1.5 | 16 | 0.15 | Knife- | 0.8 | 0.5 | 1.5 | 0.5 |
| Example 8 | | | | Coating with | | | | |
| | | | | phosphorus- | | | | |
| | | | | based | | | | |
| | | | | power type | | | | |
| | | | | flame | | | | |
| | | | | retardant | | | | |

Artificial leather manufactured under different conditions shown in Table 1 is evaluated using the following evaluation method, and the results of the evaluation are shown in Table 2 below.

1. Light Fastness

Light of 338.6 KJ/m² is irradiated on artificial leather manufactured by the methods of the embodiments 1 to 3 and comparative examples 1 to 8 according to a method defined in ISO 105-B06: 1998 condition 5, and levels of light fastness are determined using gray scale (ISO 105 A02).

2. Rubbing Fastness

Rubbing fastness is measured by an ISO 105×12 method. For evaluation of dry rubbing fastness, two test pieces having a width of 50 mm and a length of 130 mm are fixed vertically in parallel on a test board of a friction tester, and a friction stopper of the tester is covered with a white cotton fabric having a width of 50 mm and a length of 50 mm and fixed. Then, load of 9±0.2 N is applied to the friction ruler, and then the friction stopper move back and forth to a distance of 100 mm at speed of 10 times/min on the surfaces of the test pieces. Thereafter, the white cotton fabric is taken off, and a degree of contamination of the white cotton fabric is determined with gray scale for contamination to calculate a level. Wet rubbing fastness is evaluated by the same method for evaluating dry rubbing fastness, and when the wet rubbing fastness is evaluated, water is picked up to 98% to 100% in the white cotton fabric.

3. Stiffness

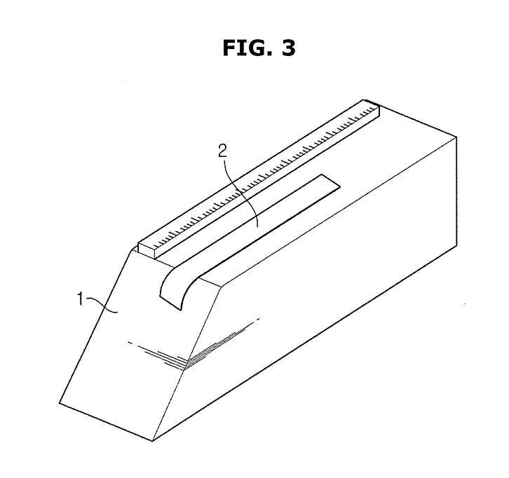

Stiffness is measured by a cantilever method KS K 0539. 5 test pieces having a width of 22 mm and a length of 150 mm in width and height directions are prepared and pressed by a pressing plate having the same size as the test pieces on a smooth horizontal bar 2 having a slope inclined at 41.5 degrees at one end to slide toward the slope, as shown in FIG. 3. Stiffness is represented as a movement distance (mm) when one ends of the test pieces contact the slope. The front and rear surfaces of the 5 test pieces are measured in the width and height directions and an average value of the measured values is calculated.

4. Combustibility

Combustibility is measured by a horizontal method KS K 0582. 5 test pieces having a width of 10.4 mm and a length of 31.8 mm in width and height directions are prepared, and a carbonization distance is measured using a Bunsen burner as a heat source for 1 minute.

| | | | Dry | Wet | | |
|---|---|---|---|---|---|---|
| | | Light | Rubbing | Rubbing | Stiffness | Combustibility |
| Classification | Blackness | Fastness | Fastness | Fastness | (mm) | (mm/min) |
| Target | 25 or | 3 or greater | 4 or greater | 4 or greater | 40-90 | 80 or smaller |
| Performance | smaller | | | | | |
| Embodiment 1 | 19.8 | 4 | 4-5 | 4 | 81 | SE |
| Comparative | 20.5 | 3 | 4 | 3-4 | 80 | SE/NBR |
| Example 1 | | | | | | |
| Comparative | 20.1 | 2-3 | 3-4 | 3-4 | 81 | SE |
| Example 2 | | | | | | |
| Embodiment 2 | 24.3 | 3-4 | 4 | 4 | 78 | 52 |
| Comparative | 24.8 | 2-3 | 3-4 | 3-4 | 80 | 48 |
| Example 3 | | | | | | |
| Comparative | 23.9 | 2 | 3 | 3 | 80 | 52 |
| Example 4 | | | | | | |
| Embodiment 3 | 16.3 | 4 | 4-5 | 4-5 | 82 | SE |
| Comparative | 15.2 | 3 | 4 | 4 | 80 | SE |
| Example 5 | | | | | | |
| Comparative | 16.4 | 2-3 | 4 | 3-4 | 81 | SE |
| Example 6 | | | | | | |
| Comparative | 21.9 | 4 | 4-5 | 4 | 81 | 110 |
| Example 7 | | | | | | |
| Comparative | 20.0 | 4 | 4-5 | 4 | 115 | SE |
| Example 8 | | | | | | |

It can be seen from Table 2 that if a carbon black content in an island component is 1.5 weight % as in the embodiments 1 to 3 when deep black artificial leather having blackness of 25 or smaller is manufactured, excellent light fastness of 3-4 level or greater, and excellent dry rubbing fastness and wet rubbing fastness of 4 level or greater are obtained, compared to the comparative examples 1 to 6.

Also, when in-bath flame-retardant treatment is performed after dyeing is completed, like the embodiment 1, the artificial leather has Self Extinguishing (SE) and stiffness of 81 mm to have a soft property. However, it can be seen that when flame-retardant treatment and dyeing are performed simultaneously, like the comparative example 7, a brightness value is 21.9 so that an amount of exhaustion of dyes is reduced, compared to the embodiment 1, and also, a carbonization distance is 110 mm so that combustibility is degraded sharply.

Also, if flame-retardant treatment is performed by knife-coating a phosphorus-based power type flame retardant on the other surface of artificial leather, like the comparative example 8, the artificial leather has SE, but stiffness rises to 115 so that the artificial leather is significantly stiffened.

In the artificial leather according to an aspect of the present disclosure and the method of manufacturing the artificial leather, by using carbon black that does not discolor by sunlight and ultraviolet (UV) light as a material of fiber components of the artificial leather, the deep black artificial leather can implement high light fastness.

Also, by performing in-bath flame-retardant treatment after dyeing and reduction-cleaning, a problem in which an in-bath flame retardant used in dyeing is taken off during reduction-cleaning can be prevented. Thereby, artificial leather for a vehicle interior material having excellent flame retardancy and a unique soft texture can be provided.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A method of manufacturing artificial leather, comprising steps of:
needle-punching a sea-island type ultrafine conjugated yarn having a sea component of easily soluble polyester and an island component of a polyester black dope-dyed yarn to form a nonwoven fabric;
wet-impregnating a polyurethane resin in the nonwoven fabric;
eluting the sea component of the nonwoven fabric;
dyeing and reduction-cleaning the nonwoven fabric from which the sea component is eluted; and
performing in-bath flame-retardant treatment on the cleaned nonwoven fabric.

2. The method according to claim 1, wherein in the step of needle-punching a sea-island type ultrafine conjugated yarn to form a nonwoven fabric, the polyester black dope-dyed yarn being the island component of the sea-island ultrafine conjugated yarn contains a carbon black component.

3. The method according to claim 2, wherein in the step of needle-punching a sea-island type ultrafine conjugated yarn to form a nonwoven fabric, the island component contains the carbon black ranging from 1.5 weight % to 3 weight % with respect to total weight of the island component.

4. The method according to claim 1, wherein in the step of needle-punching a sea-island type ultrafine conjugated yarn to form a nonwoven fabric, denier per filament of the island component ranges from 0.04 denier to 0.3 denier.

5. The method according to claim 1, wherein in the step of needle-punching a sea-island type ultrafine conjugated yarn to form a nonwoven fabric, the sea-island ultrafine conjugated yarn has 7 to 36 fibers included in the island component for each unit filament.

6. The method according to claim 1, wherein the step of wet-impregnating a polyurethane resin in the nonwoven fabric comprises wet-impregnating the polyurethane resin in the nonwoven fabric such that the polyurethane resin of 27.5 weight % to 31 weight % with respect to total weight of the artificial leather is included in the nonwoven fabric.

7. The method according to claim 1, wherein the step of performing in-bath flame-retardant treatment on the cleaned nonwoven fabric comprises performing in-bath flame-retardant treatment on the cleaned nonwoven fabric using a phosphate ester flame retardant of 15 weight % to 30 weight % with respect to weight of the artificial leather.

8. The method according to claim 7, wherein the step of performing in-bath flame-retardant treatment on the cleaned nonwoven fabric comprises performing in-bath flame-retardant treatment on the cleaned nonwoven fabric in a bath containing the phosphate ester flame retardant at a liquid ratio of 1:5 to 1:30.

9. The method according to claim 1, further comprising buffing the nonwoven fabric to raise a nap on a surface of the nonwoven fabric.

10. Artificial leather comprising:
a nonwoven fabric formed by needle-punching a sea-island type ultrafine conjugated yarn having a sea component of easily soluble polyester and an island component of a polyester black dope-dyed yarn, and eluting the sea component; and
an elastic layer formed by wet-impregnating the polyurethane resin in the nonwoven fabric.

11. The artificial leather according to claim 10, wherein the nonwoven fabric and the elastic layer are formed by dyeing and reduction-cleaning the elastic layer and the nonwoven fabric from which the sea component is eluted, and performing in-bath flame-retardant treatment on the cleaned nonwoven fabric and the cleaned elastic layer.

12. The artificial leather according to claim 10, wherein the polyester black dope-dyed yarn of the nonwoven fabric contains a carbon black component.

13. The artificial leather according to claim 12, wherein the nonwoven fabric contains the carbon black of 1.5 weight % to 3 weight % with respect to total weight of the sea component.

14. The artificial leather according to claim 10, wherein denier per filament of the sea component ranges from 0.04 denier to 0.3 denier.

15. The artificial leather according to claim 10, wherein the nonwoven fabric has 7 to 36 fibers included in the island component for each unit filament.

16. The artificial leather according to claim 10, wherein the elastic layer contains the polyurethane resin of 27.5 weight % to 31 weight % with respect to total weight of the artificial leather.

17. The artificial leather according to claim 10, wherein a nap is raised on at least one surface of the nonwoven fabric.
